(19) United States
(12) Patent Application Publication
(10) Pub. No.: US 2011/0077953 A1
(43) Pub. Date: Mar. 31, 2011

(54) SYSTEM, METHOD, AND APPARATUS TO ANALYZE LAUNCH OPPORTUNITIES

(75) Inventor: Leighton Howard, Sydney (AU)

(73) Assignee: GenericWeb Pty Ltd, Sydney (AU)

(21) Appl. No.: 12/996,388

(22) PCT Filed: Jun. 5, 2009
(86) PCT No.: PCT/AU2009/000715

§ 371 Date: Dec. 5, 2010

Related U.S. Application Data
(60) Provisional application No. 61/059,570, filed on Jun. 6, 2008.

(51) Int. Cl. G06Q 10/00

(52) U.S. Cl. 705/1.1

(57) ABSTRACT

This paper proposes a new method and architecture for populating, updating and managing the NAB. It also proposes user's Contact Information Discovery (CID). In context of populating the NAB; since the NAB of each individual subscriber will be stored in the network in future, the paper proposes CI to flow from one NAB to another NAB within the core network, instead of CI flowing from Device to Network. Thus with the user authorization, his CI would shoot from one NAB to another NAB within the core network instead of from LAB to NAB through air interface. It would reduce huge amount of data traffic on the air that otherwise would be generated in updating and populating the NAB by all the NAB users. In context of CID, the paper proposes a query-response mechanism and introduces a NAB Manager. The new architecture will provide several benefits for example it will eliminate the need of “Number Portability,” “United States National Do Not Call Registry” and “411 Directory Assistance.”

### TECHNICAL FIELD OF THE INVENTION

The invention relates to methods and systems analyzing launch opportunities for generic drug products.

### BACKGROUND OF THE INVENTION

The beginning of the development of a generic drug product is generally timed around two pieces of information, the expiry of any patent protecting the reference product, and the data exclusivity protection preventing filing and/or approval of the generic product by the regulatory authorities. These data may vary drastically between different countries where different patent and data exclusivity regulations exist and/or where regulations are interpreted differently, and so analysis of each is critical to ascertain an ideal development strategy that takes advantage of the earliest launch opportunities in markets of interest.

In Individual markets such as the USA, these data are relatively easy to ascertain once the information sources and publication protocols are known, however when analysing opportunities in many markets, the varying methods and formats in which the information is published makes direct comparison and analysis of the data determining the ideal beginning of a generic development a very complicated task.

### SUMMARY OF THE INVENTION

According to a first aspect of the invention, there is provided a method for analyzing a plurality of launch opportunities of at least one drug, or agricultural product, the method comprising:

retrieving key data relevant to the at least one drug product;

analyzing the key data to identify constraining patent or regulatory hurdles;

comparing and/or summarizing the key data to identify launch opportunities; and

displaying the launch opportunity information of the at least one drug product; wherein:

the key data is optionally patent data, data exclusivity data (or the like) or a combination thereof.

In a second aspect, there is provided a system or apparatus for analyzing a plurality of launching opportunities of at least one drug or agricultural product, the analyzing system comprising:

a data retrieving system to retrieve key data relevant to at least one drug product;

a constraining patent or regulatory hurdle system adapted to analyze the key data;

a tables and images system to compare and/or summarize the key data to identify launch opportunity information; and

a display to display the launch opportunity information of the at least one drug product; wherein:

the key data is optionally patent data, data exclusivity data (or the like) or a combination thereof.

A third aspect of the invention comprises a tangible computer-readable medium having stored thereon computer executable instructions for analyzing a plurality of launch opportunities of at least one drug or agricultural product, the computer-readable medium comprising:

program code adapted to retrieving key data relevant to the at least one drug product;

program code to analyze the key data to identify a constraining patent or regulatory hurdle;

program code adapted to compare and/or summarizie the key patent; and program code adapted to display the analyzed plurality of launch opportunities of the at least one drug product; wherein:

the key data is optionally patent data, data exclusivity data (or the like) or a combination thereof.

A fourth aspect of the invention comprises a product produced by a method or system for analyzing a plurality of launching opportunities of at least one drug or agricultural product, the product comprising a visual display functionally equivalent to that depicted in optionally FIG. 4 or FIG. 5 herein.

In a fifth aspect of the invention, there is provided a method for analyzing a plurality of launch opportunities of at least one drug product, the method comprising:
a. identifying key patents protecting the drug or agricultural product;
b. selecting a key patent publication or analysis and conducting a patent family search to identify equivalents to it in a number of predetermined countries/territories;
c. selecting a patent family for analysis and categorizing each equivalent key patent publication in the patent family into individual countries/territories;
d. selecting a country from one or more predetermined countries/territories and determining for each key patent publication associated with that country, whether it forms part of a publication sequence using a predefined set of rules and/or algorithms;
e. selecting a country from one or more predetermined countries/territories and determining, for each associated key patent publication, whether it is the most significant key patent publication in its corresponding publication sequence using a predetermined set of rules and/or algorithms;
f. selecting a country or territory from one or more predetermined countries/territories and determining, for each associated significant key patent publication, the primary procedural status by converting the kind code of one or more of the key patent publications in the publication sequence into a standardised status description;
g. selecting a country or territory from one or more predetermined countries/territories and calculating, for each associated significant key patent publication, the normal expiry date for each associated country/territory based on pre-defined algorithms for that country/territory;
h. for each significant key patent publication calculating any extended patent terms by matching the base patent publication contained in patent term extension data to one or more of the key patent publications in the corresponding publication sequence for the associated country/territory;
i. selecting a country or territory from one or more predetermined countries/territories and determine, for each product or combination thereof, the relevant First Marketing Authorisation Date appropriate for calculating the Data Exclusivity Expiry for that country/territory based on pre-defined algorithms for that country;
j. selecting a country or territory from one or more predetermined countries/territories and determine, for each product or combination thereof, the relevant Data Exclusivity Expiry based on pre-defined algorithms for that country/territory;
k. selecting a country or territory from one or more predetermined countries/territories and calculating, for each significant key patent publication the maximum allowed extended patent term based on pre-defined algorithms for that country/territory;
l. tabulating data according to a predetermined method; and
m. displaying data according to a predetermined method.

A sixth aspect of the invention comprises a tangible computer-readable medium having stored thereon computer executable instructions for analyzing a plurality of launch opportunities of at least one drug or agricultural product, the computer-readable medium comprising program code to:
a. identify key patents protecting the drug or agricultural product;
b. conduct a patent family search to identify equivalents to a selected key patent publication in a number of predetermined countries/territories;
c. categorizie each equivalent key patent publication in a patent family into individual countries/territories;
d. determine for each key patent publication associated with a country, whether it forms part of a publication sequence using a predefined set of rules and/or algorithms;
e. determine, for each associated key patent publication in a selected country or territory, whether it is the most significant key patent publication in its corresponding publication sequence using a predetermined set of rules and/or algorithms;
f. determine, for each associated significant key patent publication in a selected country or territory, the primary procedural status by converting the kind code of one or more of the key patent publications in the publication sequence into a standardised status description;
g. calculate, for each associated significant key patent publication in a selected country or territory, the normal expiry date for each associated country/territory based on pre-defined algorithms for that country/territory;
h. for each significant key patent publication calculate any extended patent terms by matching the base patent publication contained in patent term extension data to one or more of the key patent publications in the corresponding publication sequence for the associated country/territory;
i. determine, for each product or combination thereof, the relevant First Marketing Authorisation Date in a selected country or territory appropriate for calculating the Data Exclusivity Expiry for that country/territory based on pre-defined algorithms for that country;
j. determine, for each product or combination thereof in a selected country or territory, the relevant Data Exclusivity Expiry based on pre-defined algorithms for that country/territory;
k. calculate, for each significant key patent publication in a country or territory, the maximum allowed extended patent term based on pre-defined algorithms for that country/territory;
l. tabulate data according to a predetermined method; and
m. display data according to a predetermined method.

In a seventh aspect, there is provided a method for analyzing a plurality of launch opportunities of at least one drug product, the method comprising identifying key patents protecting the drug or agricultural product. In some embodiments, key patents are identified optionally from one or more of Patent Searching, Merck Index, Orange Book, SPC/Extension data or any other published source of such information.

In an eighth aspect of the invention, there is provided a method for analyzing a plurality of launch opportunities of at least one drug product, the method comprising selecting a key patent publication or analysis and conducting a patent family search to identify equivalents to it in a number of predetermined countries/territories. In some embodiments, there is a further step of repeating the selection and search steps one or more times.

A ninth aspect of the invention comprises a method for analyzing a plurality of launch opportunities of at least one drug product, the method comprising selecting a patent family for analysis and categorizing each equivalent key patent publication in the patent family into individual countries/territories. In some embodiments, the method further comprises optionally analysing designated states for EP/PCT patents & applications, extension states for EP, effect of government changes, and unpublished patent protection in developing countries). In other embodiments, there is a further step of repeating the selection and categorization steps one or more times.

In a tenth aspect of the invention, there is provided a method for analyzing a plurality of launch opportunities of at least one drug product, the method comprising selecting a country from one or more predetermined countries/territories and determining for each key patent publication associated with that country, whether it forms part of a publication sequence using a predefined set of rules and/or algorithms. In some embodiments, there is provided the step of determining the publication sequence by analysing applications sharing similar application or other data. In some embodiments, there is a further step of repeating the selection and determining steps one or more times.

An eleventh aspect of the invention is a method for analyzing a plurality of launch opportunities of at least one drug product, the method comprising selecting a country from one or more predetermined countries/territories and determining, for each associated key patent publication, whether it is the most significant key patent publication in its corresponding publication sequence using a predetermined set of rules and/or algorithms. In some embodiments, determination of significance of key patent publications is based on the highest level of legal protection afforded to the product. In some embodiments, there is a further step of repeating the selection and determining steps one or more times.

According to a twelfth aspect of the invention, there is provided a method for analyzing a plurality of launch opportunities of at least one drug product, the method comprising selecting a country or territory from one or more predetermined countries/territories and determining, for each associated significant key patent publication, the primary procedural status by converting the kind code of one or more of the key patent publications in the publication sequence into a standardised status description. In some embodiments, there is a further step of repeating the selection and determining steps one or more times.

A thirteenth aspect of the invention comprises a method for analyzing a plurality of launch opportunities of at least one drug product, the method comprising selecting a country or territory from one or more predetermined countries/territories and calculating, for each associated significant key patent publication, the normal expiry date for each associated country/territory based on pre-defined algorithms for that country/territory. In some embodiments, calculation is optionally based on one or more of application, publication, issue/grant data. In some embodiments, there is a further step of repeating the selection and calculation steps one or more times.

According to a fourteenth aspect of the invention, there is a method for analyzing a plurality of launch opportunities of at least one drug product, the method comprising for each significant key patent publication calculating any extended patent terms by matching the base patent publication contained in patent term extension data to one or more of the key patent publications in the corresponding publication sequence for the associated country/territory. In some embodiments, the matching step uses the expiry date of any matched patent term extension publication data to calculate any extended patent term, and using the Subject of the matched Patent Term Extension publication data to identify the Product Scope of the Patent Term Extension. In some embodiments, there is a further step of repeating the calculation step one or more times.

In a fifteenth aspect of the invention, there is provided a method for analyzing a plurality of launch opportunities of at least one drug product, the method comprising selecting a country or territory from one or more predetermined countries/territories and determining, for each product or combination thereof, the relevant First Marketing Authorisation Date appropriate for calculating the Data Exclusivity Expiry for that country/territory based on pre-defined algorithms for that country. In some embodiments, the determining step uses Marketing Authorisation Dates for any product containing a predetermined active ingredient and wherein Marketing Authorisation Dates may optionally be based on National or Centralised marketing authorisations, and the appropriate date may optionally be the first in a defined region containing certain countries/territories. In some embodiments, there is provided a further step of repeating the determining step one or more times.

In a sixteenth aspect of the invention, there is provided a method for analyzing a plurality of launch opportunities of at least one drug product, the method comprising selecting a country or territory from one or more predetermined countries/territories and determining, for each product or combination thereof, the relevant Data Exclusivity Expiry based on pre-defined algorithms for that country/territory. In some embodiments, there is a further step of assigning a data exclusivity type for each data exclusivity (or the like) expiry. In some embodiments, there is provided a further step of repeating the determining step one or more times.

A seventeenth aspect of the invention is a method for analyzing a plurality of launch opportunities of at least one drug product, the method comprising selecting a country or territory from one or more predetermined countries/territories and calculating, for each significant key patent publication the maximum allowed extended patent term based on pre-defined algorithms for that country/territory. In some embodiments, there is provided a further step of using the First Marketing Authorisation Date appropriate to that country/territory and optionally comparing it with Extended Patent Term. In some embodiments, Patent Term Extension publication data is used to identify discrepancies for given Key Patent Publications, and said Key Patent Publications are flagged accordingly. In some embodiments, there is provided a further step of repeating the calculating step one or more times.

In an eighteenth aspect of the invention, there is provided a method for analyzing a plurality of launch opportunities of at least one drug product, the method comprising tabulating data according to a predetermined method. In some embodiments, the predetermined method comprises:
a. listing predetermined countries/territories considered to be of concern to the user in separate rows in a first column of a table;
b. for each country row, listing each of the Significant Key Patent Publications for an individual Patent Family in a second column, each on a separate line;
c. for each Significant Key Patent Publication, optionally displaying the Primary Status, Secondary Status, Normal Patent Expiry date in additional columns;
d. for each Significant Key Patent Publication where an Extended Patent Term is applicable, optionally displaying the Extension application number, the Extension Status, Extension Subject and Extension expiry date in additional columns.
e. for each Country, displaying the Data Exclusivity Expiry date, in a separate column;
f. for each country representing any determined Missed Opportunities for extended patent term; and optionally
g. generating Mouse-over displays of data for each tabular element and generating hyperlinks to corresponding summaries of underlying data for a given country.

In a nineteenth aspect of the invention, there is provided a method for analyzing a plurality of launch opportunities of at least one drug product, the method comprising displaying data according to a predetermined method. In some embodiments, the displaying step comprises:
a. listing predetermined countries/territories considered to be of concern to the user along an axis and plotting a timeline along the perpendicular axis;
b. for each country, listing each of the Significant Key Patent Publication for an individual Patent Family on a separate line alongside the corresponding country label;
c. for each Significant Key Patent Publication, plotting a Normal Term Coverage Line that begins at the application date of the patent and ends at the normal expiry date of the patent;
d. for each Significant Key Patent Publication where an Extended Patent Term is applicable, plotting an Extension Coverage Line that begins at the Normal Expiry date of the patent and ends at the Extended Patent Term Expiry.
e. for each Country, plotting the Data Exclusivity Coverage Line, starting at the date of first marketing authorisation in the relevant state or territory and ending at the expiry of the data exclusivity in the country;
f. for each country plotting any determined Missed Opportunities for extended patent term;
g. stylising each Normal Patent, Extended Term and Data Exclusivity coverage Line according to criteria which optionally comprise ‘pending’, ‘withdrawn’, ‘based on incorrect first marketing date’; and optionally
h. generating Mouse-over displays of data for each graphical element and generating hyperlinks to corresponding summaries of underlying data for a given country.

In a twentieth aspect of the invention, there is provided a method for analyzing a plurality of launch opportunities of at least one drug product, the method comprising combining display information generated according to a method disclosed herein to compare characteristics of a plurality of patent families and/or products. In some embodiments, combined information is optionally overlaid, merged or compared side by side. In some embodiments, the plurality of patent families and/or products is preselected prior to requesting a display.

In a twenty-first aspect of the invention, there is provided a system or apparatus for analyzing a plurality of launch opportunities of at least one drug product, the system or apparatus comprising:
a. a system to identify key patents protecting the drug, veterinary or agricultural product;
b. a system to conduct a patent family search to identify equivalents to a selected key patent publication in a number of predetermined countries/territories;
c. a system to categorizie each equivalent key patent publication in a patent family into individual countries/territories;
d. a system to determine for each key patent publication associated with a country, whether it forms part of a publication sequence using a predefined set of rules and/or algorithms;
e. a system to determine, for each associated key patent publication in a selected country or territory, whether it is the most significant key patent publication in its corresponding publication sequence using a predetermined set of rules and/or algorithms;
f. a system to determine, for each associated significant key patent publication in a selected country or territory, the primary procedural status by converting the kind code of one or more of the key patent publications in the publication sequence into a standardised status description;
g. a system to calculate, for each associated significant key patent publication in a selected country or territory, the normal expiry date for each associated country/territory based on pre-defined algorithms for that country/territory;
h. a system to, for each significant key patent publication calculate any extended patent terms by matching the base patent publication contained in patent term extension data to one or more of the key patent publications in the corresponding publication sequence for the associated country/territory;
i. a system to determine, for each product or combination thereof, the relevant First Marketing Authorisation Date in a selected country or territory appropriate for calculating the Data Exclusivity Expiry for that country/territory based on pre-defined algorithms for that country;
j. a system to determine, for each product or combination thereof in a selected country or territory, the relevant Data Exclusivity Expiry based on pre-defined algorithms for that country/territory;
k. a system to calculate, for each significant key patent publication in a country or territory, the maximum allowed extended patent term based on pre-defined algorithms for that country/territory;
l. a system to tabulate data according to a predetermined method; and
m. a display to display data according to a predetermined method.

A twenty-second aspect of the invention provides system or apparatus for analyzing a plurality of launch opportunities of at least one drug product, the system or apparatus comprising:
a. a system to conduct a patent family search to identify equivalents to a selected key patent publication in a number of predetermined countries/territories;
b. a system to categorizie each equivalent key patent publication in a patent family into individual countries/territories;
c. a system to determine for each key patent publication associated with a country, whether it forms part of a publication sequence using a predefined set of rules and/or algorithms;
d. a system to determine, for each associated key patent publication in a selected country or territory, whether it is the most significant key patent publication in its corresponding publication sequence using a predetermined set of rules and/or algorithms;
e. a system to determine, for each associated significant key patent publication in a selected country or territory, the primary procedural status by converting the kind code of one or more of the key patent publications in the publication sequence into a standardised status description;
f. a system to calculate, for each associated significant key patent publication in a selected country or territory, the normal expiry date for each associated country/territory based on pre-defined algorithms for that country/territory;
g. a system to, for each significant key patent publication calculate any extended patent terms by matching the base patent publication contained in patent term extension data to one or more of the key patent publications in the corresponding publication sequence for the associated country/territory;
h. a system to determine, for each product or combination thereof, the relevant First Marketing Authorisation Date in a selected country or territory appropriate for calculating the Data Exclusivity Expiry for that country/territory based on pre-defined algorithms for that country;
i. a system to determine, for each product or combination thereof in a selected country or territory, the relevant Data Exclusivity Expiry based on pre-defined algorithms for that country/territory;
j. a system to calculate, for each significant key patent publication in a country or territory, the maximum allowed extended patent term based on pre-defined algorithms for that country/territory;
k. a system to tabulate data according to a predetermined method; and
l. a display to display data according to a predetermined method.
wherein selected patents according to item (a), above are key patents protecting the drug or agricultural product;

In a twenty-third aspect of the invention, there is provided a system or apparatus for analyzing a plurality of launch opportunities of at least one drug product, the system or apparatus comprising a system to identify key patents protecting the drug or agricultural product.

In a twenty-fourth aspect of the invention, there is provided a system or apparatus for analyzing a plurality of launch opportunities of at least one drug product, the system or apparatus comprising a system to conduct a patent family search to identify equivalents to a selected key patent publication in a number of predetermined countries/territories.

In a twenty-fifth aspect of the invention, there is provided a system or apparatus for analyzing a plurality of launch opportunities of at least one drug product, the system or apparatus comprising a system to categorizie each equivalent key patent publication in a patent family into individual countries/territories.

In a twenty-sixth aspect of the invention, there is provided a system or apparatus for analyzing a plurality of launch opportunities of at least one drug product, the system or apparatus comprising a system to determine for each key patent publication associated with a country, whether it forms part of a publication sequence using a predefined set of rules and/or algorithms.

In a twenty-seventh aspect of the invention, there is provided a system or apparatus for analyzing a plurality of launch opportunities of at least one drug product, the system or apparatus comprising a system to determine, for each associated key patent publication in a selected country or territory, whether it is the most significant key patent publication in its corresponding publication sequence using a predetermined set of rules and/or algorithms.

In a twenty-eighth aspect of the invention, there is provided a system or apparatus for analyzing a plurality of launch opportunities of at least one drug product, the system or apparatus comprising a system to determine, for each associated significant key patent publication in a selected country or territory, the primary procedural status by converting the kind code of one or more of the key patent publications in the publication sequence into a standardised status description.

In a twenty-ninth aspect of the invention, there is provided a system or apparatus for analyzing a plurality of launch opportunities of at least one drug product, the system or apparatus comprising a system to calculate, for each associated significant key patent publication in a selected country or territory, the normal expiry date for each associated country/territory based on pre-defined algorithms for that country/territory.

In a thirtieth aspect of the invention, there is provided a system or apparatus for analyzing a plurality of launch opportunities of at least one drug product, the system or apparatus comprising a system to, for each significant key patent publication calculate any extended patent terms by matching the base patent publication contained in patent term extension data to one or more of the key patent publications in the corresponding publication sequence for the associated country/territory.

In a thirty-first aspect of the invention, there is provided a system or apparatus for analyzing a plurality of launch opportunities of at least one drug product, the system or apparatus comprising a system to determine, for each product or combination thereof, the relevant First Marketing Authorisation Date in a selected country or territory appropriate for calculating the Data Exclusivity Expiry for that country/territory based on pre-defined algorithms for that country.

In a thirty-second aspect of the invention, there is provided a system or apparatus for analyzing a plurality of launch opportunities of at least one drug product, the system or apparatus comprising a system to determine, for each product or combination thereof in a selected country or territory, the relevant Data Exclusivity Expiry based on pre-defined algorithms for that country/territory.

In a thirty-third aspect of the invention, there is provided a system or apparatus for analyzing a plurality of launch opportunities of at least one drug product, the system or apparatus comprising a system to calculate, for each significant key patent publication in a country or territory, the maximum allowed extended patent term based on pre-defined algorithms for that country/territory;

In a thirty-fourth aspect of the invention, there is provided a system or apparatus for analyzing a plurality of launch opportunities of at least one drug product, the system or apparatus comprising a system to tabulate data according to a predetermined method.

In a thirty-fifth aspect of the invention, there is provided a system or apparatus for analyzing a plurality of launch opportunities of at least one drug product, the system or apparatus comprising a display to display data according to a predetermined method.

Examples of displays described above which might be produced in accordance with the invention are herein represented in non-limiting FIGS. 4 and 5.

Any of the embodiments illustrated herein stand independently, and any features or embodiments may be combined in any way, unless expressly excluded, to achieve a preferred embodiment. Additional advantages and embodiments of the invention will also become more apparent to those of ordinary skill in the art upon review of the teachings of the description of the preferred embodiments, and from the claims.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of one embodiment of a system or apparatus according to the present invention.

FIG. 2 is a diagrammatic representation of one embodiment of a networked system or apparatus according to the present invention.

FIG. 3 is a flow chart showing the interactivity of modules 1 to 14 of the system, apparatus, or method (as for example embodied in machine readable code, or software) with the memory of the overall system or apparatus.

FIG. 4 is an example graphical representation of multiple launch opportunities produced in accordance with the invention.

FIG. 5 is an example tabular representation of multiple launch opportunities produced in accordance with the invention.

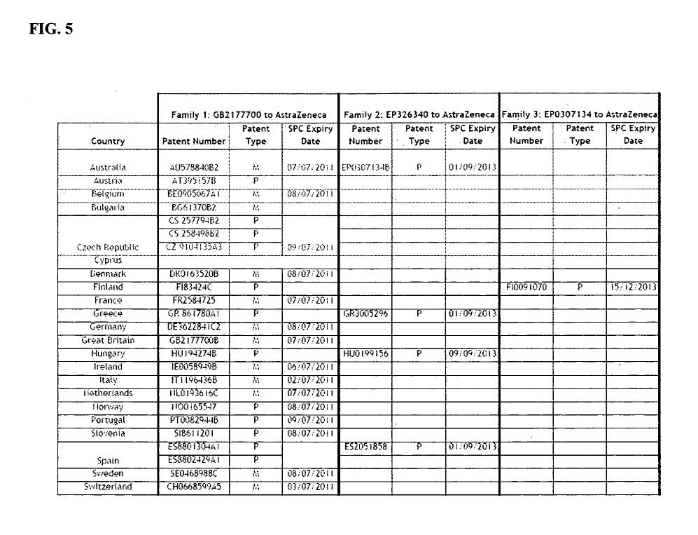

### DETAILED DESCRIPTION

It is convenient to describe the invention herein in relation to particularly preferred embodiments. However, the invention is applicable to a wide range of situations and applications and it is to be appreciated that other constructions and arrangements are also considered as falling within the scope of the invention. Various modifications, alterations, variations and or additions to the construction and arrangements described herein are also considered as falling within the ambit and scope of the present invention.

The term ‘data exclusivity’ as used herein refers to any restriction imposed by a government regulatory authority on the first date at which a generic drug company may eventually launch a generic product. This, it refers to any or all of the below examples, as well as others:
1. where a government regulatory authority will refuse to rely on innovator data before a certain date;
2. where a government regulatory authority will not allow a generic application to be filed until a certain date;
3. where a government regulatory authority will not allow marketing approval before a certain date;
4. where a government regulatory authority will not approve a generic application until a certain date;
5. and so on

The term ‘patent’ as used herein refers to any registrable intellectual property right which protects an invention or innovation and includes applications for such rights. Accordingly, it may comprise patents, standard patents, utility patents, innovation patents, petty patents, utility models, design patents, innovation patents, PCT applications, and the like and regardless of their status, which may for example include applied for, pending, granted, issued, lapsed, expired, withdrawn, and so on.

In some preferred embodiments of the invention, there are provided a plurality of methods as set out below, each of which may be used in combination with one or more other or alternative methods in order to provide the desired result. These methods may be implemented in any suitable fashion, in some embodiments, one or more components of software or hardware, or the like each enable functionality of each method and the corresponding software or hardware or the like is herein referred to as Module [number] Software, Module [number] Hardware, or similar. For the sake of clarity, software corresponding to Method one is referred to as Module One Software.

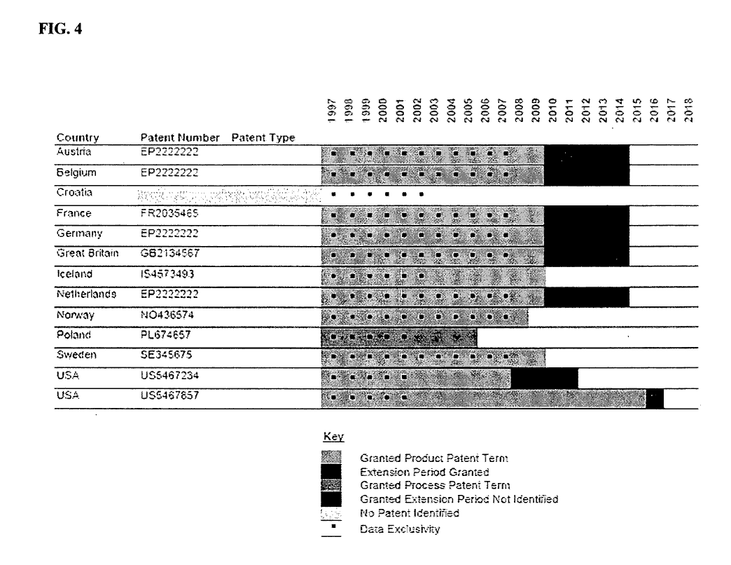

According to some embodiments, the methods are used in sequence to produce information relevant to multiple launch opportunities for a generic drug product which may, for example be displayed in a fashion functionally equivalent to that depicted in FIG. 4.

### Method and Module One—Identification of ‘Seed’ Key Patents

Identify Key Patents protecting a Drug or Agrochemical Product (as defined by Active Ingredient, INN, Brand Name or other characterising feature) using conventional means (Patent Searching, Merck Index, Orange Book, SPC/Extension data or any other published source of such information).

In some embodiments of the invention, a server associated with the system and method of the invention will communicate with a server or computer housing the required information and interrogate a database thereon in order to obtain the required information. Thus in the example of obtaining Orange Book information, the server will retrieve information available on a website such as http://www.accessdata.fda.gov/. In this case, the information may comprise data associated with the various patent numbers, patent expiration dates, Drug Substance Claim and Drug Product Claim information, Patent Use Codes and so on. This retrieved information may then be entered into a database associated with the search which is underway in a form which is accessible for further parts of the method.

Similarly, online versions of the Merck Index, or databases of SPCs, etc may be accessed in the same way.

This method results in a list of Key Patent Publication numbers, each associated with one or more Drug or Agrochemical Products.

### Method and Module Two—Identification of Families of Key Patents

Select a Key Patent Publication for analysis and conduct a patent family search to identify equivalents to the Key Patent Publication in a number of predetermined countries/territories. Repeat for each Key Patent Publication.

In some embodiments of the invention, a server associated with the system and method of the invention will select the Key Patent Publication based on a predetermined criterion, such as oldest priority date, patentee, and so on. In some embodiments, the Key Patent Publication is chosen at this step purely randomly. A server associated with the system and method may then communicate with a server or computer housing the required patent family information and interrogate a database thereon in order to obtain the required information.

Thus, for example, a server associated with the invention may access a database such as http://ep.espacenet.com/ and cause a patent number (such as a application, publication, or other patent number) to be searched in the database and then retrieve the search results.

This method results in a number of Patent Families, each containing equivalent Key Patent Publications related by priority application and a corresponding Kind Code, and other Published Data associated with the Patent Family and/or Key Patent Publication.

### Method and Module Three—Allocation of Country Coverage of Key Patents in Family

Select a Patent Family for analysis and categorise each equivalent Key Patent Publication in the Patent Family into individual countries/territories (requires analysis of designated states for EP/PCT patents & applications, extension states for EP, effect of government changes e.g. CZ/SK, YU/HG/MK, and unpublished Pipeline patent protection in developing countries). Repeat for each Patent Family.

In some embodiments of the invention, a server associated with the system and method of the invention will select the Patent Family based on a predetermined criterion, such as oldest priority date, patentee, and so on. In some embodiments, the Patent Family chosen at this step purely randomly.

This method results in a Country Coverage List for each Patent Family containing a list of pre-determined countries/territories, each associated with one or more Key Patent Publications having legal coverage in that country/territory.

Method and Module Four—Identification of Publication Sequence amongst Key Patent Publications

Select a country from one or more predetermined countries/territories and determine, for each Key Patent Publication associated with that country, whether it forms part of a Publication Sequence using a predefined set of rules and algorithms (Publication Sequence being determined by applications sharing similar application or other data e.g. publication of the granted patent, supercedes publication of corresponding application, translation or search report in significance). Repeat for each predetermined country/territory.

The predetermined countries and initial countries of interest can be selected in any suitable way. It may for example be a country of high significance to the end user, such as a production centre or distribution hub, or it may be selected randomly.

This method results in list of Key Patent Publications, each associated with a single Publication Sequence for a given country/territory, each representing separate protection (or applications therefor) in single country/territory in the Country Coverage List of a particular Patent Family.

Method and Module Five—Identification of Significant Key Patent Publication in each Sequence

Select a country from one or more predetermined countries/territories and determine, for each associated Key Patent Publication, whether it is the most Significant Key Patent Publication in its corresponding Publication Sequence using a predefined set of rules and algorithms (Significance being based on highest level of legal protection afforded to the Drug, Veterinary or Agrochemical Product based on the Kind Code). Repeat for each predetermined country/territory.

In some embodiments, Significance of a Key Patent Publication is determined by steps such as:
1. searching a database (such as an online database) for information associated with a Key Patent Publication
2. Identifying the most recent Kind Code associated with that Key Patent Publication
3. Attributing a level of significance to the Key Patent Publication based on the Kind Code.
4. Comparing Kind Codes and attributing relative significance to Key Patent Publications.

Kind Codes are classifications that explain the status of a patent application in broad terms. Thus, for example a Kind Code of ‘A’ in some countries means that the patent application has been published, but not yet granted or issued. An example list of Kind Codes can be found at http://www.epo.org/patents/patent-information/raw-data/useful-tables.html. Thus one of the benefits of a method such as this is that the Key Patent Publications are sorted based on the likely level of threat. There is certainty about the scope of the granted claims of a granted patent, but the scope of a published but not yet examined patent is uncertain. A further benefit of a method such as this is that the Key Patent Publications can be filtered to display to the end user only the most recent and therefore most significant document in a patent application series.

This method results in a list of Significant Key Patent Publications, each corresponding to a separate Publication Sequence, each associated with one or more countries/territories in the Country Coverage List of a particular Patent Family.

### Method and Module Six—Determination of Primary Status of Significant Key Patent Publications

Select a country from one or more predetermined countries/territories and determine, for each associated Significant Key Patent Publication, the Primary Procedural Status by converting the Kind Code of one or more of the Key Patent Publications in the Publication Sequence into a standardised status description e.g. Pending, Granted. Repeat for each predetermined country/territory.

This method may be conducted for example by searching for the Kind Code and country information for a particular Key Patent Publication in a database and extracting an equivalent description for that Kind Code and that Country from the database. In some embodiments this description may be converted to a standardized patent status to assist the end user in understanding the current procedural status and enforceability of an identified Significant Key Patent Publication.

This method results in a list of Significant Key Patent Publications, each having a Primary Procedural Status for each associated country/territory in the Country Coverage List of a particular Patent Family.

### Method and Module Seven—Determination of Normal Expiry of Significant Key Patent Publications

Select a country from one or more predetermined countries/territories and calculate, for each associated Significant Key Patent Publication, the Normal Expiry Date for each associated country/territory based on pre-defined algorithms for that country/territory using Published Data, e.g. application, publication, issue/grant data, related to each Significant Key Patent Publication. Repeat for each predetermined country/territory.

This method may for example be conducted by steps such as:
1. Identify a Expiry Date-determining datapoint in relation to a Significant Key Patent Publication. (This may be any suitable datapoint. For example, in many instances it will comprise the filing date of the Full application, such as a PCT application.)
2. Identify the country of interest from an identifier associated with the Key Patent Publication identifier.

3. Search in a database for an expiry calculation method associated with the country of interest. The algorithm may take any suitable form, and in its simplest form, merely adds 20 years to the filing date of the Full Application (such as a PCT application). However, it may also take into account a plurality of patent expiry determining data points and alter the calculation accordingly. Thus for example, in the case of patents originally filed in the United States prior to the change from a 17 year term to a 20 year term, it may determine from the filing date whether the calculation should be based on the date of filing the Full application, or the date of Issue of the patent in question.
4. Calculate the expiry date based on the identified expiry calculation method.
5. Return the calculated expiry date.

This method results in a list of Significant Key Patent Publications, each having a Normal Expiry Date for each associated country/territory in the Country Coverage List of a particular Patent Family.

### Method and Module Eight—Determination of Extended Patent Term

For each Significant Key Patent Publication calculate any Extended Patent Terms by matching the Base Patent Publication contained in Patent Term Extension (SPC, CCP, s156, s170) publication data to one or more of the Key Patent Publications in the corresponding Publication Sequence for the associated country/territory, using the expiry date of any matched Patent Term Extension publication data to calculate any Extended Patent Term, and using the Subject of the matched Patent Term Extension publication data to identify the Product Scope of the Patent Term Extension.

So for example, in some countries, a patent term extension equivalent to the time taken after the patent is filed until Marketing Authorisation is obtained less five years (and up to a maximum of five years) may be granted.

In one embodiment of the invention, a database of patent term extension calculation methods relevant to each jurisdiction may be housed at a suitable location. The database can be searched based on the jurisdiction of a Significant Key Patent Publication and a computer can run the calculation based on the recovered calculation method. Thus, the predetermined algorithm or calculation method would identify the Significant Key Patent Publication filing date, the expiry date of the patent, the Marketing Authorisation date and calculate the extended term.

In another embodiment a database of Patent Term Extensions for all countries which grant such extensions may be searched for extensions corresponding to a Significant Key Patent Publication. The database may be stored locally, for example on a computer used by the user, or remotely and may be accessed via a network, such as the internet.

In some embodiments, a database comprising granted patent term extensions may be available and searched to see whether an actual patent term extension has been granted. This embodiment is important because in some instances, the patentee may not apply for a patent term extension, it may be denied, or it may be successfully opposed.

This method results in a list of Significant Key Patent Publications, each optionally having one or more Extended Patent Terms for each associated country/territory in the Country Coverage List of a particular Patent Family, each Extended Patent Term having an associated Product Scope.

In one embodiment a database of Patent Term Extensions for all countries which grant such extensions may be searched for extensions corresponding to the selected country, to retrieve the first marketing authorization date for the country or region that may have been submitted as part of the Patent Term Extension Application.

The database may be stored locally, for example on a computer used by the user, or remotely and may be accessed via a network, such as the internet.

### Method and Module Nine—Determination of Relevant First Marketing Authorisations

Select a country from one or more predetermined countries/territories and determine, for each Non-Proprietary Name (INN, USAN etc.) or Combination thereof, the relevant First Marketing Authorisation Date appropriate for calculating the Data Exclusivity Expiry for that country/territory based on pre-defined algorithms for that country/territory using Marketing Authorisation Dates for any Drug, Veterinary or Agrochemical Product containing an active ingredient associated with said Non-Proprietary Name (Marketing Authorisation Dates may be based on National or Centralised marketing authorisations, and the appropriate date may be the first in a defined region containing certain countries/territories). Repeat for each predetermined country/territory.

Countries may be selected in any suitable way and in any suitable order. In some embodiments, they are selected according to relative importance to the user.

In one embodiment of the invention, where conflicting dates for Non-Proprietary Name (INN, USAN etc.) or Combination thereof in a particular country or region are identified, an algorithm may automatically select a date for that country or the database record may be flagged for manual resolution of the most applicable date to be used in later processing or display to the end user.

This method results in list of First Marketing Authorisation Dates for each of the predetermined countries/territories for each Non-Proprietary Name.

### Method and Module Ten—Calculation of Data Exclusivity Expiry

Select a country from one or more predetermined countries/territories and determine, for each Non-Proprietary Name or combination thereof, the relevant Data Exclusivity Expiry based on pre-defined algorithms for that country/territory using the First Marketing Authorisation Date appropriate to that country/territory and/or based on pre-determined data exclusivity information for a Drug or Agrochemical Product containing an active ingredient associated with said Non-Proprietary Name and assign a Data Exclusivity Type for each Data Exclusivity Expiry based on marketing authorisation details associated with the First Marketing Authorisation Date used and/or based on pre-determined data exclusivity information for a Drug, Veterinary or Agrochemical Product containing an active ingredient associated with said Non-Proprietary Name.

In the same way as for patent term extensions, this method may for example be undertaken by (a) calculating the data exclusivity period or (b) searching a database of granted data exclusivities for a granted data exclusivity in relation to the Product in question.

Again, in a similar manner to that described above, in some embodiments, there is a database housing algorithms for calculating data exclusivities for each country. This database can be searched and the particular algorithm applied depending on the selected country.

This method results in list of Data Exclusivity Expiry for each of the predetermined countries/territories for each Non-Proprietary Name with associated Data Exclusivity Type.

### Method and Module Eleven—Calculation of Missed Opportunities

Select a country from one or more predetermined countries/territories and calculate, for each Significant Key Patent Publication the Maximum Allowed Extended Patent Term based on pre-defined algorithms for that country/territory using the First Marketing Authorisation Date appropriate to that country/territory and optionally compare it with Extended Patent Term determined by methods based on Patent Term Extension publication data to identify discrepancies for given Key Patent Publications, and flagging said Key Patent Publications accordingly.

This method may for example be conducted by comparing a database of actual patent term expiries (whether expired or not) with those calculated as the Maximum Allowed Extended Terms. Again, the algorithms for calculating the Maximum Allowed Extended

Terms for each country may be housed in a database which can be searched and the appropriate algorithm applied depending on the country of interest.

This method results in list of Significant Key Patent Publications, each having a Maximum Allowed Extended Patent Term for each associated country/territory in the Country Coverage List of a particular Patent Family and optionally having one or more flags to indicate discrepancies between Maximum Allowed Extended Patent Term and Extended Patent Term.

Method and Module Twelve—Tabulating Data on a Country by Country Basis for a each family

List predetermined countries/territories considered to be of concern to the user in separate rows in a first column of a table. This list may be generated automatically in response to predetermined questions which for example determine the user's major markets, supply chain points and so on. Alternatively, a user may input the list.

Aggregate data from relevant steps one to twelve into a computer readable and graphic displayable form.

For each country row, list each of the Significant Key Patent Publication for an individual Patent Family (containing a Key Patent Publication) in a second column, each on a separate line.

For each Significant Key Patent Publication, optionally display the Primary Status, Secondary Status, Normal Patent Expiry date in additional columns.

For each Significant Key Patent Publication where an Extended Patent Term is applicable, optionally display the Extension application number, the Extension Status, Extension Subject and Extension expiry date in additional columns.

For each Country, display the Data Exclusivity Expiry date, in a separate column.

For each Country represent any determined Missed Opportunities for extended patent term.

Generate Mouse-over displays of data for each tabular element and generate hyperlinks to corresponding summaries of underlying data for a given country.

Method and Module Thirteen—Displaying Data on a Country by Country Basis for a each Family

Aggregate data from relevant steps one to twelve into a computer readable and graphic displayable form.

List predetermined countries/territories considered to be of concern to the user along an axis and plot a timeline along the perpendicular axis. This list may be generated automatically in response to predetermined questions which for example determine the user's major markets, supply chain points and so on. Alternatively, a user may input the list.

For each country, list each of the Significant Key Patent Publication for an individual Patent Family (containing a Key Patent Publication) on a separate line alongside the corresponding country label.

For each Significant Key Patent Publication, plot a Normal Term Coverage Line that begins at the application date of the patent and ends at the normal expiry date of the patent.

For each Significant Key Patent Publication where an Extended Patent Term is applicable, plot an Extension Coverage Line that begins at the Normal Expiry date of the patent and ends at the Extended Patent Term Expiry. This line may be the same or a different style to the Normal Term Coverage line.

For each Country, plot the Data Exclusivity Coverage Line, starting at the date of first marketing authorisation in the relevant state or territory and ending at the expiry of the data exclusivity in the country. This line may be the same or a different style to the Normal Term and Extended Term Coverage line for each Significant Key Patent Publication, and may overlay one or all for clarity.

For each country plot any determined Missed Opportunities for extended patent term.

Stylise each Normal Patent, Extended Term and Data Exclusivity coverage Line according to predetermined criteria e.g. pending, withdrawn, based on incorrect first marketing date etc.

Generate Mouse-over displays of data for each graphical element and generate hyperlinks to corresponding summaries of underlying data for a given country.

### Method and Module Fourteen—Comparing Multiple Patent Families.

In order to compare more than one patent family that is considered to be of interest in determining launch opportunities, such tabular or graphical information for Multiple Families may be overlaid, merged or compared side by side by preselecting the families of interest prior to requesting a display.

### Example System or Apparatus Components and Functionality

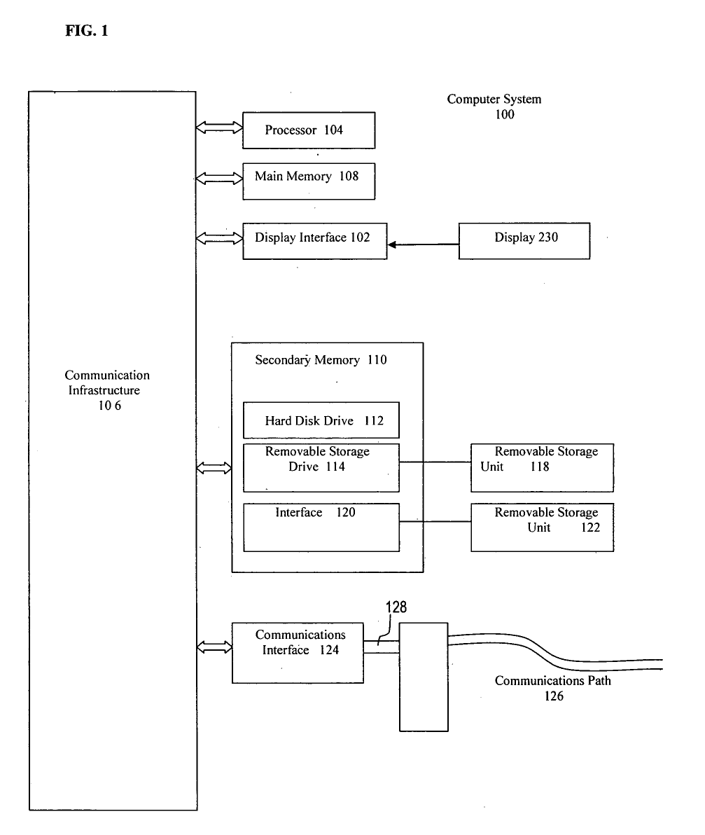

The present invention may be implemented using hardware, software, or a combination thereof and may be implemented in one or more computer systems or other processing systems. In one embodiment, the invention is directed toward one or more computer systems capable of carrying out the functionality described herein. An example of such a computer system is shown in FIG. 1.

A computer implementing the methods described herein can operate in a “real-time” or “off-line” fashion. “Real-time” means that the results of the method are computed only as and when requested by an end user using the most recently available versions of the various source data. “Off-line” means that the results are computed independently of the request (either in anticipation of a potential request or in response to a request). In this way, computation can be scheduled for specific periods, such as generating the results in batches overnight. Combinations of the two methods, whereby some parts are computed in batches and cached whereas others are performed in “real-time” can be used to balance the computing power required per implemented result and the requirement to have the most up-to-date results possible.

The methods of the present invention can technically run on a device with surprisingly low (by modern standards) computing power such as 100 MB of memory and a 500 MHz processor CPU. However, such a system would suffer performance issues if large numbers of users were to seek to send instructions to have the device perform the method of the invention in “real-time”.

Note that modern server CPUs have 4-6 cores per CPU and 2-4 CPUs per server, each core operating at over 1 GHz clock speed. Thus for example, a system comprising a standard modern server with 8-cores (2×4 core CPUs), could significantly out-perform the above described machine and could service a higher volume of requests per measure of time in “real-time” mode.

Computer system 100 includes one or more processors, such as processor 104. The processor 104 is connected to a communication infrastructure 106 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 100 can include a display interface 102 that forwards graphics, text, and other data from the communication infrastructure 106 (or from a frame buffer not shown) for display on the display unit 130. Computer system 100 also includes a main memory 108, preferably random access memory (RAM), and may also include a secondary memory no. The secondary memory no may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well-known manner. Removable storage unit 118, represents a floppy disk, magnetic tape, optical disk, etc., which is read by and written to removable storage drive 114. As will be appreciated, the removable storage unit 118 includes a computer usable storage medium having stored therein computer software and/or data.

In alternative embodiments, secondary memory no may include other similar devices for allowing computer programs or other instructions to be loaded into computer system 100. Such devices may include, for example, a removable storage unit 122 and an interface 120. Examples of such may include a program cartridge and cartridge interface (such as that found in video game devices), a removable memory chip (such as an erasable programmable read only memory (EPROM), or programmable read only memory (PROM)) and associated socket, and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 224 may include a modem, a network interface (such as an Ethernet card), a communications port, a Personal Computer Memory Card International Association (PCMCIA) slot and card, etc. Software and data transferred via communications interface 124 are in the form of signals 128, which may be electronic, electromagnetic, optical or other signals capable of being received by communications interface 124. These signals 128 are provided to communications interface 124 via a communications path (e.g., channel) 126. This path 126 carries signals 128 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 114, a hard disk installed in hard disk drive 112, and signals 128. These computer program products provide software to the computer system 100. The invention is directed to such computer program products.

Computer programs (also referred to as computer control logic) are stored in main memory 108 and/or secondary memory 110. Computer programs may also be received via communications interface 124. Such computer programs, when executed, enable the computer system 100 to perform the features of the present invention, as discussed herein. In particular, the computer programs, when executed, enable the processor 104 to perform the features of the present invention. Accordingly, such computer programs represent controllers of the computer system 200.

In an embodiment where the invention is implemented using software, the software may be stored in a computer program product and loaded into computer system 100 using removable storage drive 114, hard drive 112, or communications interface 124. The control logic (software), when executed by the processor 104, causes the processor 104 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

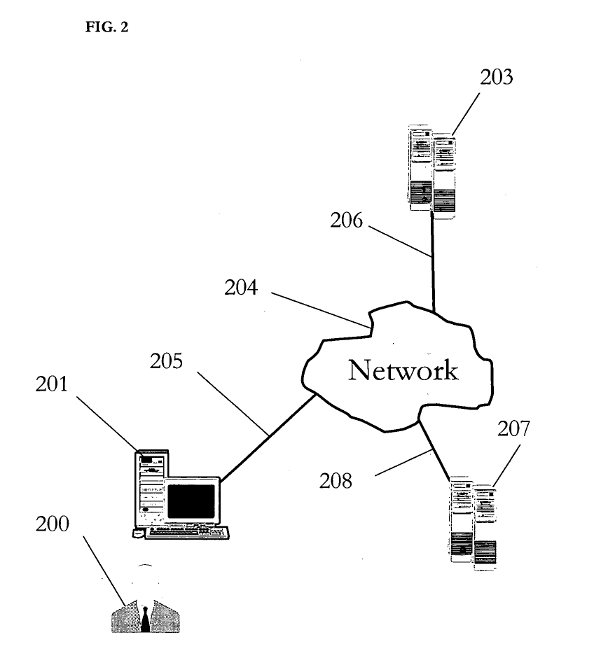

As shown in FIG. 2, in an embodiment of the present invention, the multimedia application operates, for example, on a network. A user 200, such as an applicant or application processor inputs information, via a terminal 201, such as a personal computer (PC), minicomputer, mainframe computer, microcomputer, telephone device, personal digital assistant (PDA), or other device having a processor and input capability.

As further shown in FIG. 2, in one embodiment, the terminal 201 is coupled to a server 203, such as a PC, minicomputer, mainframe computer, microcomputer, or other device having a processor and a repository for data or connection to a repository for maintained data, via a network 204, such as the Internet, via couplings 205, 206, such as wired, wireless, or fiber optic connections. Although preferred embodiments of the invention have been described in the foregoing description, it will be understood that the invention is not limited to the specific embodiments disclosed herein but is capable of numerous modifications by one of ordinary skill in the art. It will be understood that the materials used and technological details may be slightly different or modified from the descriptions herein without departing from the methods and compositions disclosed and taught by the present invention. Many variations and modifications will be apparent to those of ordinary skill in the art. For example, the invention is applicable to a wide range of situations, attributes, environmental attributes, information holders and organizations and it is to be appreciated that other constructions and arrangements are also considered as falling within the scope of the invention.

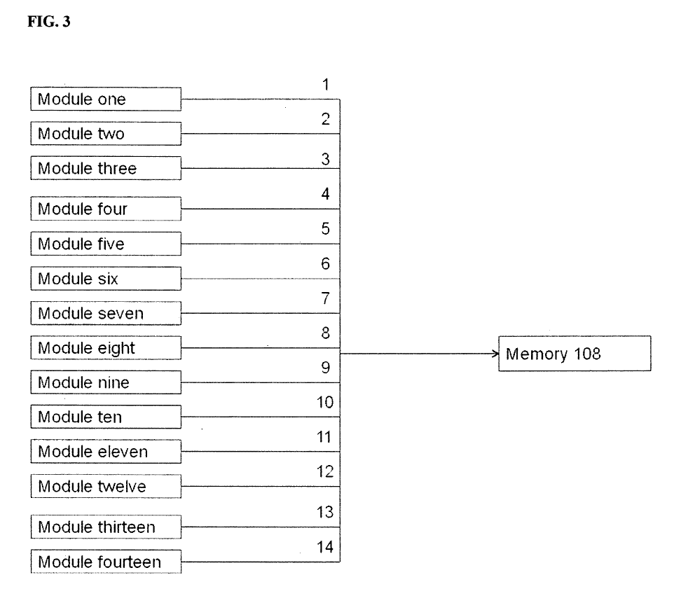

As shown in FIG. 3, any one or more of modules one to fourteen (which may be physically embodied as software or code or the like on a machine readable medium, or may at least in part comprise hardware) may interact with memory 108 of computer System 100 (as depicted in FIG. 1). Consequently, the invention allows for some but not all modules to be utilized in any given embodiment. In the depicted embodiment, the modules are utilized and applied by memory 108 in sequence as shown by numbers 1 to 14.

1. A method for analyzing a plurality of launch opportunities of at least one drug or agricultural or agricultural product, the method comprising:
retrieving key data relevant to the at least one drug product; and
analyzing the key data to identify constraining patent or regulatory hurdles;
[comparing and/or summarizing the key data to identify launch opportunities; and displaying the launch opportunity information of the at least one drug or agricultural product; wherein:]
the key data is optionally patent data, data exclusivity data (or the like) or a combination thereof.

2. A method according to claim 1 comprising the steps of: comparing and/or summarizing the key data to identify launch opportunities; and displaying the launch opportunity information of the at least one drug or agricultural product.

3. A method [for analyzing a plurality of launch opportunities of at least one drug or agricultural product, the product] according to claim 1 comprising one or more of the steps of:
a. identifying key patents protecting the drug or agricultural product;
b. selecting a key patent publication or analysis and conducting a patent family search to identify equivalents to it in a number of predetermined countries/territories;
c. selecting a patent family for analysis and categorizing each equivalent key patent publication in the patent family into individual countries/territories;
d. selecting a country from one or more predetermined countries/territories and determining for each key patent publication associated with that country, whether it forms part of a publication sequence using a predefined set of rules and/or algorithms;
e. selecting a country from one or more predetermined countries/territories and determining, for each associated key patent publication, whether it is the most significant key patent publication in its corresponding publication sequence using a predetermined set of rules and/or algorithms;
f. selecting a country or territory from one or more predetermined countries/territories and determining, for each associated significant key patent publication, the primary procedural status by converting the kind code of one or more of the key patent publications in the publication sequence into a standardised status description;
g. selecting a country or territory from one or more predetermined countries/territories and calculating, for each associated significant key patent publication, the normal expiry date for each associated country/territory based on pre-defined algorithms for that country/territory;
h. for each significant key patent publication calculating any extended patent terms by matching the base patent publication contained in patent term extension data to one or more of the key patent publications in the corresponding publication sequence for the associated country/territory;
i. selecting a country or territory from one or more predetermined countries/territories and determine, for each product or combination thereof, the relevant First Marketing Authorisation Date appropriate for calculating the Data Exclusivity Expiry for that country/territory based on pre-defined algorithms for that country;
j. selecting a country or territory from one or more predetermined countries/territories and determine, for each product or combination thereof, the relevant Data Exclusivity Expiry based on pre-defined algorithms for that country/territory;
k. selecting a country or territory from one or more predetermined countries/territories and calculating, for each significant key patent publication the maximum allowed, extended patent term based on predefined algorithms for that country/territory;
l. tabulating data according to a predetermined method; and,
m. displaying data according to a predetermined method.

4. A method [for analyzing a plurality of launch opportunities of at least one drug or agricultural product, the method] according to claim 1 comprising the step of identifying key patents protecting the drug or agricultural product.

5. A method [for analyzing a plurality of launch opportunities of at least one drug or agricultural product, the method] according to claim 1 comprising the steps of selecting a key patent publication or analysis and conducting a patent family search to identify equivalents to it in a number of predetermined countries and territories.

6. A method [for analyzing a plurality of launch opportunities of at least one drug or agricultural product, the method] according to claim 1 comprising the step of selecting a patent family for analysis and categorizing each equivalent key patent publication in the patent family into individual countries/territories.

7. A method [for analyzing a plurality of launch opportunities of at least one drug or agricultural product, the method] according to claim 1 comprising the step of selecting a country from one or more predetermined countries/territories and determining for each key patent publication associated with that country, whether it forms part of a publication sequence using a predefined set of rules and/or algorithms.

8. A method [for analyzing a plurality of launch opportunities of at least one drug or agricultural product, the method] according to claim 1 comprising the step of selecting a country from one or more predetermined countries/territories and determining for each associated key patent publication, whether it is the most significant key patent publication in its corresponding publication sequence using a predetermined set of rules and/or algorithms.

9. A method [for analyzing a plurality of launch opportunities of at least one drug or agricultural product, the method] according to claim 1 comprising the step of a selecting country or territory from one or more predetermined countries/territories and determining, for each associated significant key patent publication, the primary procedural status by converting the kind code of one or more of the key patent publications in the publication sequence into a standardized status description.

10. A method [for analyzing a plurality of launch opportunities of at least one drug or agricultural product, the method] according to claim 1 comprising the step of selecting a country or territory from one or more predetermined countries/territories and calculating, for each associated significant key patent publication, the normal expiry date for each associated country/territory based on pre-defined algorithms for that country/territory

11. A method [for analyzing a plurality of launch opportunities of at least one drug or agricultural product, the method] according to claim 1 comprising the steps of for each significant key patent publication calculating any extended patent terms by matching the base patent publication contained in patent term extension data to one or more of the key patent publications in the corresponding publication sequence for the associated country/territory.

12. A method [for analyzing a plurality of launch opportunities of at least one drug or agricultural product, the method] according to claim 1 comprising the step of selecting a country or territory from one or more predetermined countries/territories and determining, for each product or combination thereof, the relevant First Marketing Authorisation Date appropriate for calculating the Data Exclusivity Expiry for that country/territory based on pre-defined algorithms for that country.

13. A method [for analyzing a plurality of launch opportunities of at least one drug or agricultural product, the method] according to claim 1 comprising the step of selecting a country or territory from one or more predetermined countries/territories and determining, for each product for each product or combination thereof, the relevant Data Exclusivity Expiry based on pre-defined algorithms for that country/territory.

14. A method [for analyzing a plurality of launch opportunities of at least one drug or agricultural product, the method] according to claim 1 comprising the step of selecting a country or territory from one or more predetermined countries/territories and calculating, for each significant key a patent publication the maximum allowed extended patent term based on pre-defined algorithms for that country/territory.

15. A method [for analyzing a plurality of launch opportunities of at least one drug or agricultural product, the method] according to claim 1 comprising the step of tabulating data according to a predetermined method.

16. A method [for analyzing a plurality of launch opportunities of at least one drug or agricultural product, the method] according to claim 1 comprising the step of displaying data according to a predetermined method.

17. A method [for analyzing a plurality of launch opportunities of at least one drug or agricultural product, the method] according to claim 1 comprising the step of combining display information generated according to a method of [anyone of claims 1 to 40] claim 3 to compare characteristics of a plurality of patent families and/or products.

18. A system or apparatus for analyzing a plurality of launching opportunities of at least one drug or agricultural product, the analyzing system comprising: a constraining patent or regulatory hurdle system adapted to analyze key data wherein the key date is optionally patent data, data exclusivity data (or like) or a combination thereof

19. A system or apparatus [for analyzing a plurality of launch opportunities of at least one drug or agricultural product, the analyzing system] according to claim 18 comprising:
a data retrieving system to retrieve key data relevant to at least one drug or agricultural product;
[a constraining patent or regulatory hurdle system adapted to analyze key data]
a tables and images system to compare and/or summarize the key data to identify launch opportunity information; and
a display to display the launch opportunity information of the at least one drug or agricultural product[: wherein the key date is optionally patent data, data exclusivity data (or like) or a combination thereof].

20. A system or apparatus [for analyzing a plurality of launch opportunities of at least one drug or agricultural product, the system or apparatus] according to claim 18 optionally comprising one or more of:
a. a system to identify key patents protecting the drug or agricultural product;
b. a system to conduct a patent family search to identify equivalents to a selected key patent publication in a number of predetermined countries/territories;
c. a system to categorize each equivalent key patent publication in a patent family into individual countries/territories;
d. a system to determine for each key patent publication associated with a country, whether it forms part of a publication sequence using a predefined set of rules and/or algorithms;
e. a system to determine, for each associated key patent publication in a selected country or territory, whether it is the most significant key patent publication in its corresponding publication sequence using a predetermined set of rules and/or algorithms;
f. a system to determine, for each associated significant key patent publication in a selected country or territory, the primary procedural status by converting the kind code of one or more of the key patent publications in the publication sequence into a standardised status description;
g. a system to calculate, for each associated significant key patent publication in a selected country or territory, the normal expiry date for each associated country/territory based on pre-defined algorithms for that country/territory;
h. a system to, for each significant key patent publication calculate any extended patent terms by matching the base patent publication contained in patent term extension data to one or more of the key patent publications in the corresponding publication sequence for the associated country/territory;
i. a system to determine, for each product or combination thereof, the relevant First Marketing Authorisation Date in a selected country or territory appropriate for calculating the Data Exclusivity Expiry for that country/territory based on pre-defined algorithms for that country;
j. system to determine, for each product or combination thereof in a selected country or territory, the relevant Data Exclusivity Expiry based on predefined algorithms for that country/territory;
k. a system to calculate, for each significant key patent publication in a country or territory, the maximum allowed extended patent term based on predefined algorithms for that country/territory;
l. a system to tabulate data according to a predetermined method; and
m. a display to display data according to a predetermined method.

21. A system or apparatus [for analyzing a plurality of launch opportunities of at least one drug or agricultural product, the system or apparatus] according to claim 18 optionally comprising one or more of:
a. a system to conduct a patent family search to identify equivalents to a selected key patent publication in a number of predetermined countries/territories;
b. a system to categorize each equivalent key patent publication in a patent family into individual countries/territories;
c. a system to determine for each key patent publication associated with a country, whether it forms part of a publication sequence using a predefined set of rules and/or algorithms;
d. a system to determine, for each associated key patent publication in a selected country or territory, whether it is the most significant key patent publication in its corresponding publication sequence using a predetermined set of rules and/or algorithms;
e. a system to determine, for each associated significant key patent publication in a selected country or territory, the primary procedural status by converting the kind code of one or more of the key patent publications in the publication sequence into a standardised status description;
f. a system to calculate, for each associated significant key patent publication in a selected country or territory, the normal expiry date for each associated country/territory based on pre-defined algorithms for that country/territory;
g. a system to, for each significant key patent publication calculate any extended patent terms by matching the base patent publication contained in patent term extension data to one or more of the key patent publications in the corresponding publication sequence for the associated country/territory;
h. a system to determine, for each product or combination thereof, the relevant First Marketing Authorisation Date in a selected country or territory appropriate for calculating the Data Exclusivity Expiry for that country/territory based on pre-defined algorithms for that country;
i. a system to determine, for each product or combination thereof in a selected country or territory, the relevant Data Exclusivity Expiry based on predefined algorithms for that country/territory;
j. a system to calculate, for each significant key patent publication in a country or territory, the maximum allowed extended patent term based on predefined algorithms for that country/territory;
k. a system to tabulate data according to a predetermined method; and
l. a display to display data according to a predetermined method, wherein selected patents according to item (a), above are key patents protecting the drug or agricultural product;

22. A system or apparatus [for analyzing a plurality of launch opportunities of at least one drug or agricultural product, the system or apparatus] according to claim 18 comprising a system to identify key patents protecting the drug or agricultural product.

23. A system or apparatus [for analyzing a plurality of launch opportunities of at least one drug or agricultural product, the system or apparatus] according to claim 18 comprising a system to conduct a patent family search to identify equivalents to a selected key patent publication in a number of predetermined countries/territories.

24. A system or apparatus [for analyzing a plurality of launch opportunities of at least one drug or agricultural product, the system or apparatus] according to claim 18 comprising a system to categorize each equivalent key patent publication in a patent family into individual countries/territories.

25. A system or apparatus [for analyzing a plurality of launch opportunities of at least one drug or agricultural product, the system or apparatus] according to claim 18 comprising a system to determine for each key patent publication associated with a country, whether it forms part of a publication sequence using a predefined set of rules and/or algorithms.

26. A system or apparatus [for analyzing a plurality of launch opportunities of at least one drug or agricultural product, the system or apparatus] according to claim 18 comprising a system to determine, for each associated key patent publication in a selected country or territory, whether it is the most significant key patent publication in its corresponding publication sequence using a predetermined set of rules and/or algorithms.

27. A system or apparatus [for analyzing a plurality of launch opportunities of at least one drug or agricultural product, the system or apparatus] according to claim 18 comprising a system to determine, for each associated significant key patent publication in a selected country or territory, the primary procedural status by converting the kind code of one or more of the key patent publications in the publication sequence into a standardised status description.

28. A system or apparatus [for analyzing a plurality of launch opportunities of at least one drug or agricultural product, the system or apparatus] according to claim 18 comprising a system to calculate, for each associated significant key patent publication in a selected country, or territory, the normal expiry date for each associated country/territory based on predefined algorithms for that country/territory.

29. A system or apparatus [for analyzing a plurality of launch opportunities of at least one drug or agricultural product, the system or apparatus] according to claim 18 comprising a system to, for each significant key patent publication calculate any extended patent terms by matching the base patent publication contained in patent term extension data to one or more of the key patent publications in the corresponding publication sequence for the associated country/territory.

30. A system or apparatus [for analyzing a plurality of launch opportunities of at least one drug or agricultural product, the system or apparatus] according to claim 18 comprising a system to determine, for each product or combination thereof, the relevant First Marketing Authorisation Date in a selected country or territory appropriate for calculating the Data Exclusivity Expiry for that country/territory based on pre-defined algorithms for that country.

31. A system or apparatus [for analyzing a plurality of launch opportunities of at least one drug or agricultural product, the system or apparatus] according to claim 18 comprising a system to determine, for each product or combination thereof in a selected country or territory, the relevant Data Exclusivity Expiry based on pre-defined algorithms for that country/territory.

32. A system or apparatus [for analyzing a plurality of launch opportunities of at least one drug or agricultural product, the system or apparatus] according to claim 18 comprising a system to calculate, for each significant key patent publication in a country or territory, the maximum allowed extended patent term based on pre-defined algorithms for that country/territory.

33. A system or apparatus [for analyzing a plurality of launch opportunities of at least one drug or agricultural product, the system or apparatus] according to claim 18 comprising a system to tabulate data according to a predetermined method.

34. A system or apparatus [for analyzing a plurality of launch opportunities of at least one drug or agricultural product, the system or apparatus] according to claim 18 comprising a display to display data according to a predetermined method.

35. A tangible computer-readable medium having stored thereon computer executable instructions for analyzing a plurality of launch opportunities of at least one drug or agricultural product, the computer-readable medium comprising:
program code adapted to retrieving key data relevant to the at least one drug or agricultural product;
program code to analyze the key data to identify a constraining patent or regulatory hurdle;
program code adapted to compare and/or summarize the key patent; and
program code adapted to display the analyzed plurality of launch opportunities of the at least one drug or agricultural product; wherein:
the key data is optionally patent data, data exclusivity data (or the like) or a combination thereof.
